(19) United States
(12) Patent Application Publication
(10) Pub. No.: US 2024/0177903 A1
(43) Pub. Date: May 30, 2024

(54) MAGNETIC COMPONENT

(71) Applicant: Delta Electronics (Thailand) Public Co., Ltd., Samutprakarn (TH)

(72) Inventors: Hugues NJIENDE, Paderborn (DE); Ralf GRIEGER, Soest (DE); Sergey TIKHONOV, Bad Sassendorf (DE)

(21) Appl. No.: 18/522,268

(22) Filed: Nov. 29, 2023

(30) Foreign Application Priority Data
Nov. 30, 2022 (EP) 22210507.4

(51) Int. Cl. H01F 3/14; H01F 27/26

(52) U.S. Cl. CPC H01F 3/14; H01F 27/26; H01F 2003/103

(57) ABSTRACT

The disclosure concerns a magnetic component comprising at least one magnetic core, wherein at least one gap is formed between surfaces, especially opposing end surface(s) and/or side surface(s), of the magnetic core(s), wherein a direction extending between said surfaces is defined as a gap extension direction, a gap distribution device comprising at least one magnetic piece and at least one holding frame configured to hold the at least one magnetic piece, wherein the gap distribution device is arranged within said at least one gap of the at least one magnetic core such that the at least one magnetic piece is arranged within said gap, and at least one electrical winding wound around the at least one magnetic core and/or the at least one holding frame of the gap distribution device.

### CROSS-REFERENCE TO RELATED APPLICATION

This application claims priority to European Patent Application No. 22210507.4, filed on Nov. 30, 2022, which is hereby incorporated by reference in its entirety.

### TECHNICAL FIELD

The present disclosure concerns a magnetic component, particularly for magnetic components for power converters.

### BACKGROUND

Conventional magnetic components, for example for power converters, comprise one or more magnetic cores and one or more electrical windings. Therein, air gaps in these magnetic cores or between multiple magnetic cores are used in order to control the inductance or to increase a saturation current of the magnetic component. It is conventionally known to distribute air gaps for reducing AC copper losses. Therein, ferrite plates are distributed within the gap of the magnetic component so as to split the gap into a plurality of smaller gaps interposed between the ferrite plates.

U.S. Pat. No. 5,315,279 discloses a coil device including magnetic cores having gap regions in a coil wound to contain the gap regions. Therein, a shape of at least one of the opposing magnetic cores forming the gap regions is formed into a curve of logarithmic function from its base end to its extreme end, its most extreme end being provided with a gap adjusting flat surface and a plurality of gaps being formed in the gap regions.

US 2015/0 235 749 A1 discloses a magnetic core utilized in a reactor which includes an upper yoke, a bottom yoke, and at least two core columns. Therein, a closed magnetic loop is formed by the upper yoke, the bottom yoke, and the core columns. The core columns include at least one first magnetic column which includes a core body, a balance magnetic unit and an air gap. The balance magnetic unit and the adjacent air gap form a composite air gap for dividing the first magnetic column into different parts.

U.S. Pat. No. 9,831,033 B2 discloses a method for fabricating magnetic cores, wherein the magnetic cores have at least two materials with different magnetic properties. The materials are selected from a ferrite material, an oxide ceramic material and a superparamagnetic material and are formed alternately in individual regions along the magnetic core.

However, the known approaches to configuring air gaps commonly provide an inductance which is linear to current and have, despite known configuration efforts, high AC losses and low power density. Furthermore, the conventionally known magnetic components can only be cooled inefficiently. The manufacturing and assembly procedures for the conventional magnetic components are also arduous and expensive, as the coils are conventionally used for holding the components within the gap.

### SUMMARY

It is an object of the present disclosure to provide a magnetic component with low AC losses, high power density, and which can be manufacturing and cooled in an efficient manner.

In particular, the solution of this object is achieved by a magnetic component. The magnetic component comprises at least one magnetic core, wherein at least one gap is formed between surfaces of the magnetic core(s). The at least one gap is especially formed between opposing end surface(s) and/or side surface(s) of the magnetic core(s). A direction extending between said surfaces is defined as a gap extension direction. Furthermore, the magnetic component comprises a gap distribution device comprising at least one magnetic piece and at least one holding frame configured to hold the at least one magnetic piece. The gap distribution device is arranged within said at least one gap of the at least one magnetic core such that the at least one magnetic piece is arranged within said gap. At least one electrical winding is wound around the at least one magnetic core and/or the at least one holding frame of the gap distribution device.

Thereby, especially via the gap distribution device, the magnetic component provides an easy and cost efficient means for distributing the at least one gap. Furthermore, the magnetic component, especially the gap distribution device, can be efficiently cooled.

In an implementation of the present disclosure, in the case of one magnetic core is utilized, the one magnetic core comprises a loop-shape, for instance a D-, 0-, or U-shape, the D-shape or O-shape having a slit portion as a gap.

Further in an implementation of the present disclosure, the gap is formed between two opposing end surfaces of one or more magnetic cores. In the case of being formed between two opposing end surfaces of one magnetic core, for example, the gap is formed as the slit portion in the exemplary D-, O-, or U-shape. In the case of being formed between two opposing end surfaces of two magnetic cores, for example, the gap is formed between opposing end surfaces of legs of one or more of the two magnetic cores. In this case, both magnetic cores each comprise one or more legs (for example, in rake-shaped cores), or only one of the magnetic cores comprises one or more legs. In the former, for example, “WW” or “E∃” configurations of the magnetic cores are exemplary used. In the latter, for example, “UI” or “EI” or “II” configurations of the magnetic cores are exemplary used.

In cases in which one or more of the gaps is formed between two surfaces, one of which not being an end surface of a leg (for instance, in “UI” or “EI” or “II”, etc. configurations), one of the opposing surfaces is a side surface.

In an implementation of the present disclosure, the gap distribution device replaces, at least partially, one or more legs of an exemplary rake-shaped configuration. For example, in an “EA” or “WM” or “WW” or “MM” or “EI” or “UI” or “WI” etc. configuration, the gap distribution device replaces one or more, especially all legs of the core members (e.g. the magnetic cores). For example, in an “E∃” configuration, one or more outer legs and/or the middle leg of at least one of the cores (E or ∃) is at least partially, especially entirely, replaced by a gap distribution device. In such an example, in case the middle leg of both cores is replaced, this would equate to a “UU” configuration, with one or more gap distribution devices being arranged between side surfaces of each “U”, between the legs of each “U”.

In an implementation of the present disclosure, the at least one electrical winding is a component, especially a coil, separate from the holding unit (e.g. the holding frame). Further, the holding unit is a one-piece component. Further, each of the magnetic pieces is a one-piece component, especially separate from the at least one magnetic core and/or the at least one electrical winding.

In an implementation of the present disclosure, no parts, components, or portions of the at least one magnetic core are disposed within the gap. Further, no parts, components, or portions of the at least one electrical winding are disposed within the gap.

In an implementation of the present disclosure, the holding frame comprises a plurality of spaces, each configured to accommodate at least one magnetic piece. Further, each space is configured to accommodate a plurality of magnetic pieces.

In an implementation of the present disclosure, at least one of the spaces is a slot.

In an implementation of the present disclosure, at least one of the spaces of the holding frame comprises a cross-sectional shape and/or a cross-sectional surface area different from the cross-sectional shape and/or the cross-sectional surface area of the at least one other space.

In an implementation of the present disclosure, at least two of the spaces of the holding frame comprises different cross-sectional shapes and/or a cross-sectional surface areas.

In an implementation of the present disclosure, a cross-section of the cross-sectional shape and/or the cross-sectional surface area is a cross-section in a plane perpendicular to the gap extension direction. In other words, for example, the cross-sectional surface area and/or cross-sectional shape define a plane extending perpendicular to the gap extension direction. In addition or alternatively thereto, the cross-section is defined as a plane parallel to the gap extension direction. In other words, the gap extension direction lies within the plane defined by such a cross-sectional surface area and/or cross-sectional shape.

In an implementation of the present disclosure, the at least one magnetic piece is insertable into the holding frame parallel to the gap extension direction. Therein, at least one of the plurality of spaces of the holding frame comprises an opening which opens the plurality of spaces in the gap extension direction. In an implementation, the at least one magnetic piece is insertable into the holding frame in a pre-installed state of the gap distribution device. In other words, the at least one magnetic piece is inserted into the holding frame before installing the gap distribution device in the magnetic component.

In addition or alternatively to the at least one magnetic piece being insertable parallel to the gap extension direction, the at least one magnetic piece is insertable along a direction at an angle to the gap extension direction in an implementation of the present disclosure. For instance, the at least one magnetic piece is insertable along a direction perpendicular to the gap extension direction. In another example, the at least one magnetic piece is insertable along an insertion direction which has an angle of less or more than 90°, for example roughly 45°, to the gap extension direction.

In one embodiment, the magnetic component comprises a plurality of magnetic pieces, wherein at least one of the magnetic pieces comprises a cross-sectional shape and/or a cross-sectional surface area different from the cross-sectional shape and/or the cross-sectional surface area of the at least one other magnetic piece.

In one embodiment, the magnetic component further comprises a plurality of magnetic pieces, wherein at least two of the magnetic pieces comprise different cross-sectional shapes and/or cross-sectional surface areas.

In an implementation of the present disclosure, the cross-sectional shape and/or cross-sectional surface area of the magnetic pieces is defined as plane-perpendicular or plane-parallel to the gap extension direction.

In an implementation of the present disclosure, the cross-sectional shapes of the plurality of magnetic pieces change and/or the cross-sectional surface areas of the plurality of magnetic pieces decrease, especially continuously decrease and/or change, along the gap extension direction. For example, a thickness (part of the cross-sectional shape and/or of the cross-sectional surface area plane-parallel to the gap extension direction) of the magnetic pieces decreases continuously from one surface to the other along the gap extension direction.

In a further example, in addition or alternatively to the foregoing described example, a width and/or height (cross-sectional surface area and/or cross-sectional shape plane-perpendicular to the gap extension direction) decreases continuously along the gap extension direction.

In an implementation of the present disclosure, the foregoing term “continuously” is defined such that the corresponding cross-sectional shape and/or cross-sectional surface area of the magnetic pieces changes with a certain pattern (i.e. decreases) for a plurality of magnetic pieces along the gap extension direction. For example, a first magnetic piece has a larger width and height than a second magnetic piece arranged along the gap extension direction after the first magnetic piece, and the second magnetic piece has a larger width and height than a third magnetic piece arranged after the second magnetic piece in gap extension direction. In other words, the term “continuously” indicates a repetition of pattern.

In an implementation of the present disclosure, the cross-sectional shapes and/or the cross-sectional surface areas of the plurality of magnetic pieces alternate. In another implementation, the alternating cross-sectional surface areas and/or cross-sectional shapes of the plurality of magnetic pieces define, from a side-view perpendicular to the gap extension direction (i.e. a view on the plane-parallel cross-section) an H-shape or an inverted H-shape.

For example, the height (plane-perpendicular and plane-parallel) of a first magnetic piece is larger than a height of a second magnetic piece, and the height of a third magnetic piece is also larger than the height of the second magnetic, the three magnetic pieces being arranged in this order along the gap extension direction (H-shape).

In addition or alternatively thereto, this shape may be inverted, such that the height of the second magnetic piece is larger than heights of the first and third magnetic pieces (inverted H-shape).

In an implementation of the present disclosure, in order to achieve the H-shape and/or inverted H-shape, the heights of the respective larger magnetic pieces and/or of the respective smaller magnetic pieces are not necessarily the same. For instance, although the height of the first magnetic piece is larger than the height of the second magnetic piece, and the height of the third magnetic piece is larger than the height of the second magnetic piece, the heights of the first and third magnetic pieces do not necessarily need to be equal (asymmetrical H-shape). The same holds true for the inverted H-shape, wherein especially the heights of the smaller magnetic pieces are not necessarily equal to one another (asymmetrical inverted H-shape).

In an implementation of the present disclosure, the configurations of cross-sectional shape and/or cross-sectional surface area along the plane-parallel direction are combined with the cross-sectional surface area and/or cross-sectional shape configurations along the plane-perpendicular direction.

In an implementation of the present disclosure, the cross-sectional surface areas and/or cross-sectional shapes of the plurality of magnetic pieces define an asymmetric shape with respect to the gap. For instance, a plane perpendicular to the gap extension direction, especially in a longitudinal (i.e. along the extension direction thereof) center of the gap, does not define a symmetry plane of the cross-sectional surface areas and/or cross-sectional shapes of the plurality of magnetic pieces. Further, for instance, a plane parallel to the gap extension direction, especially in a transverse (i.e. crossing the extension direction thereof) center of the gap, does not define a symmetry plane of the cross-sectional surface areas and/or cross-sectional shapes of the plurality of magnetic pieces. The foregoing term “does not define a symmetry plane” is synonymous with “defines a non-symmetry plane”.

Examples of symmetric shapes are the H-shape and/or the inverted H-shape, with the respective larger pieces and/or smaller pieces being configured with the same cross-sectional surface areas and/or cross-sectional shapes.

Further, one or both of the aforementioned plane perpendicular to the gap extension direction and the plane parallel to the gap extension direction define a symmetry plane of the cross-sectional surface areas and/or cross-sectional shapes of the plurality of magnetic pieces.

In one embodiment, at least one of the magnetic pieces comprises at least one notch and/or at least one groove. Therein, the at least one holding frame respectively comprises a projection configured to be insertable into the at least one notch and/or at least one groove. In an implementation, in the case of a groove, the groove extends along the gap extension direction. In addition or alternatively thereto, the groove of the at least one magnetic piece is formed in a spiral-shape so as to correspond to a screw thread. In another implementation, the projection and/or groove of the at least one holding frame corresponds to the shape of the at least one notch and/or groove of the at least one magnetic piece so as to be insertable therein. Therein, the term “corresponds to” essentially defines that the projection of the holding frame is an inverse of the shape of the at least one notch and/or at least one groove of the at least one magnetic piece.

In an implementation of the present disclosure, the projection is rib-shaped and extends along the gap extension direction so as to be insertable into the at least one notch and/or the at least one groove of a plurality of magnetic pieces.

In one embodiment, a cross-sectional shape of the at least one holding frame is circular and/or rectangular. In another implementation, the shape of the opposing end surfaces of the at least one magnetic core is circular, and the cross-sectional shape of the at least one holding frame is rectangular or vice-versa.

In a further example, the cross-sectional shape of the end surfaces of the at least one magnetic core is rectangular, and the cross-sectional shape of the at least one holding frame is circular. In the foregoing, with respect to the cross-sectional shape of the at least one holding frame and/or of the opposing end surfaces of the at least one magnetic core, the cross-section refers to the plane-perpendicular cross-section.

In an implementation of the present disclosure, the magnetic component further comprises at least one non-magnetic, especially ceramic, piece. The at least one non-magnetic piece is configured to be at least partially arranged within the at least one gap and is especially configured to be housed within the holding frame.

In an implementation of the present disclosure, the holding frame comprises at least one space additional to the spaces for accommodating the at least one magnetic piece for accommodating the at least one non-magnetic piece, especially for accommodating only the at least one non-magnetic piece.

In an implementation of the present disclosure, the at least one non-magnetic piece is configured to be housed within the holding frame, wherein at least one space of the holding frame is configured to respectively accommodate at least one magnetic piece and at least one non-magnetic piece.

In an implementation of the present disclosure, the at least one non-magnetic piece, especially a plurality of non-magnetic pieces, comprise(s) the same configuration embodiments of the at least one magnetic piece described above. For example, a plurality of non-magnetic pieces is arranged also in an H-shape, an inverted H-shape, each symmetrical or asymmetrical with regard to planes parallel and/or perpendicular to the gap extension direction.

In an implementation of the present disclosure, the at least one non-magnetic piece comprises at least one notch and/or at least one groove, especially corresponding to the foregoing configuration examples of magnetic pieces.

In an implementation of the present disclosure, the at least one non-magnetic piece and the at least one magnetic piece are stacked along the gap extension direction and/or stacked in a direction perpendicular to the gap extension direction.

In the case that the at least one non-magnetic piece and the at least one magnetic piece are stacked in a direction perpendicular to the gap extension direction, the respective spaces of the holding frame comprise the same cross-sectional shapes and/or cross-sectional surface areas. In this case, when the plurality of magnetic pieces comprise cross-sectional shapes and/or cross-sectional surface areas different from one another, the cross-sectional surface areas and/or cross-sectional shapes of the plurality of non-magnetic pieces also change in correspondence with the change of shapes and/or surface areas of the magnetic pieces. For instance, in the case that the cross-sectional shapes and/or surface areas of the magnetic pieces decrease along the gap extension direction, the cross-sectional surface areas and/or shapes of the non-magnetic pieces increase along the same direction. Thereby, the cross-sectional shape and/or cross-sectional surface area of the spaces of the holding frame are equal to one another, whereas the cross-sectional surface areas and/or cross-sectional shapes of the magnetic pieces change. The same holds true with respect to the plane-parallel and/or plane-perpendicular direction with respect to the cross-sectional surface areas and/or cross-sectional shapes of the spaces of the holding frame and/or of the non-magnetic pieces and/or of the magnetic pieces.

In an implementation of the present disclosure, the magnetic component further comprises thermal paste which is disposed in the at least one holding frame and/or disposed between the at least one holding frame and at least one of the surfaces of the magnetic cores. In another implementation, the thermal paste is disposed between one or more walls of the at least one holding frame and respective magnetic pieces disposed within the holding frame.

In an implementation of the present disclosure, the magnetic component comprises multiple magnetic cores, wherein at least one of the magnetic cores comprises a body portion and at least one leg. The at least one leg extends along the gap extension direction. The at least one gap is formed between a respective end surface of the at least one leg and a surface of another magnetic core, especially a surface of another leg of the other magnetic core. In an implementation therein, one holding frame is respectively arranged in each gap between the multiple magnetic cores.

In an implementation of the present disclosure, each magnetic core defines winding legs and return legs. The winding legs comprise electrical winding wound around them. The return legs comprise no electrical winding, and function so as to close the magnetic circuit generated in the winding legs. In an implementation, the winding legs of one magnetic core oppose the winding legs of the other magnetic core. Therein, one holding frame is arranged between each pair of opposing winding legs of the two magnetic cores. In an implementation, no holding frame is arranged between return legs of multiple magnetic cores.

In an implementation of the present disclosure, the at least one holding frame of the gap distribution device further comprises at least one recess. Further, the gap distribution device further comprises at least one fringing field shielding plate. Therein, especially in each recess, at least one fringing field shielding plate is disposed. The fringing field shield plates shield fringing fields generated between the magnetic pieces within the gap.

In an implementation of the present disclosure, the fringing field shield plates are also formed of a magnetic material. In an implementation, the fringing field shield plates are formed of the same material as the magnetic pieces, ferrite.

In an implementation of the present disclosure, one fringing field shield plate is disposed adjacent to a gap, especially at least one fringing field shield plate disposed adjacent to each gap, formed between two magnetic pieces. In an implementation, fringing field shield plates and recesses are disposed on one or more sides of the holding frame and surround the gap, i.e. surround the magnetic and non-magnetic pieces.

Further, the fringing field shield plates are formed integrally with the holding frame. In an implementation, the recesses are formed as internal spaces or slots in which fringing field shield plates are inserted/placed. In one example, the at least one fringing field shield plates are disposed within a mold before injection molding the holding frame, in the case that the holding frame is injection molded.

The present disclosure also concerns a gap distribution device for use in a magnetic circuit of a magnetic component. Therein, the gap distribution device comprises at least one magnetic piece and at least one holding frame configured to hold the at least one magnetic piece. Therein, the at least one holding frame is configured to be disposable, especially insertable, in a gap of the magnetic circuit of a magnetic component such that the at least one magnetic piece is at least partially arranged within the gap.

In an implementation of the present disclosure, the at least one magnetic piece and/or the at least one holding frame of the gap distribution device is configured corresponding to the foregoing exemplary embodiments of the magnetic component, especially the gap distribution device included therein. In particular, the gap distribution device comprises non-magnetic pieces, especially corresponding to the foregoing explanations thereto, and/or thermal paste, especially corresponding to the foregoing descriptions thereto.

### BRIEF DESCRIPTION OF DRAWINGS

Further details, advantages, and features of the embodiments of the present disclosure are described in detail with reference to the figures.

FIG. 1 shows a schematic cross section of a magnetic component according to a first embodiment;

FIG. 2 shows a schematic detailed cross section of a gap distribution device of the magnetic component according to the first embodiment;

FIGS. 3 to 6 show modifications to magnetic pieces of the gap distribution device of the magnetic component according to the first embodiment;

FIG. 7 shows a schematic cross section of a magnetic component according to a second embodiment;

FIG. 8 shows a schematic cross section of a magnetic component according to a third embodiment;

FIGS. 9 to 11 show schematic detailed cross sections of modifications to gap distribution devices of a magnetic component according to the foregoing embodiments;

FIGS. 12 to 23 show schematic cross sections of modifications to magnetic components according to the foregoing embodiments;

FIG. 24 shows a perspective view of a gap distribution device of the magnetic component according to the foregoing embodiments; and

FIG. 25 shows a schematic cross-section of a gap distribution device of a magnetic component according to a fourth embodiment.

### DESCRIPTION OF EMBODIMENTS

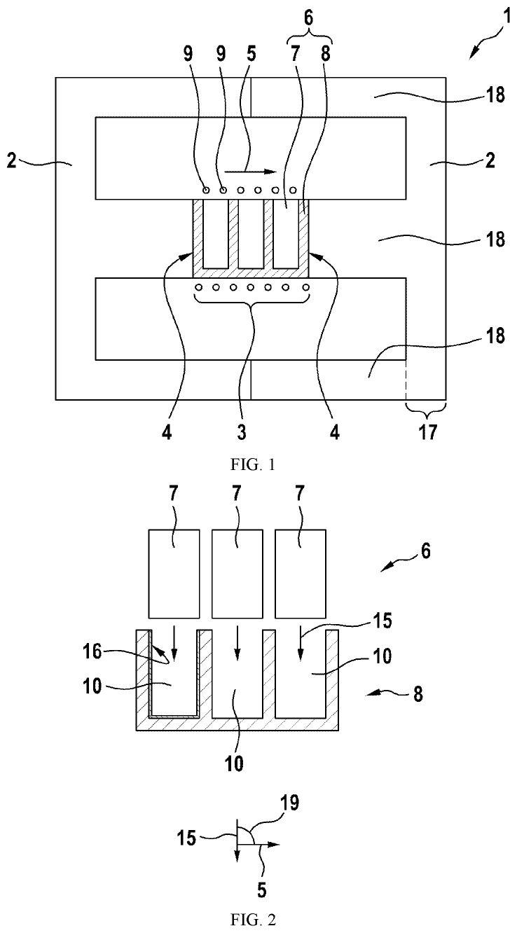

FIG. 1 shows a schematic cross section of a magnetic component 1 according to a first embodiment of the present disclosure.

The magnetic component 1 comprises two magnetic cores 2. Therein, a gap 3 is formed between the two magnetic cores 2. The gap 3 is formed between opposing end surfaces 4 of the two magnetic cores 2. A direction extending between said surfaces 4 is defined as a gap extension direction 5.

In particular, each magnetic core 2 comprises a body portion 17 substantially perpendicular to the gap extension direction 5 as well as three legs 18 each extending parallel to the gap extension direction 5. Herein, the gap 3 is formed between middle legs 18 of both magnetic cores 2.

Furthermore, the magnetic component 1 comprises an electrical winding 9 wound around the two magnetic cores 2 at the gap 3. Although not shown in FIG. 1, the magnetic component 1 may comprise more than two magnetic cores 2. Furthermore, each of the magnetic cores 2 may comprise more than three legs 18. In addition, legs 18 around which electrical windings 9 are wound are referred to as “winding legs”, wherein legs 18 (for instance top and bottom of FIG. 1) which do not comprise an electrical winding 9 are defined as “return legs”, and close a magnetic circuit generated via the electrical winding(s) 9. For instance, the magnetic cores 2 of the magnetic component 1 may for example comprise three winding legs and two return legs.

The magnetic component 1 further comprises a gap distribution device 6. The gap distribution device 6 comprises three magnetic pieces 7 and a holding frame 8 which holds and houses the magnetic pieces 7. In the present embodiment, the magnetic pieces 7 comprise a ferrite material.

Further, in the present embodiment, the holding frame 8 comprises a plastic with high thermal conductivity and/or comprises a ceramic.

In an implementation, the holding frame 8 consists of said plastic and/or consists of said ceramic.

Thereby, the gap distribution device 6 distributes the gap 3. Thereby, instead of extending from one opposing end surface 4 to the other, the gap 3 essentially extends in the spaces between the magnetic pieces 7, i.e. the spaces here defined by walls of the holding frame 8.

FIG. 2 shows a schematic detailed cross section of the gap distribution device 6 of the magnetic component 1 according to the first embodiment shown in FIG. 1.

As can be taken therefrom, the holding frame 8 of the gap distribution device 6 comprises three spaces 10 each configured to accommodate one magnetic piece 7.

In particular, FIG. 2 essentially shows a pre-installed state of the gap distribution device 6. In other words, FIG. 2 shows a state in which the gap distribution device 6 has not been installed in the magnetic component 1, i.e. disposed in the gap 3 thereof.

Therein, the magnetic pieces 7 are inserted into the holding frame 8 along an insertion direction 15 perpendicular to the gap extension direction 5. In the present embodiment, an angle 19 between the gap extension direction 5 and the insertion direction 15 of the magnetic pieces 7 into the holding frame 8 is roughly 90°. However, the spaces 10, i.e. the walls of the holding frame 8, may also be slanted with regard to the gap extension direction 5 such that the insertion direction 15 of the magnetic pieces 7 is not perpendicular to the gap extension direction 5. For instance, the angle 19 may be roughly between and including 30° and 80°, between and including 40° and 70°, between and including 50° and 60°, substantially 45°, or any one of the aforementioned values.

In addition, thermal paste 16 may be disposed within one or more of the spaces 10, especially prior to the insertion of the magnetic pieces 7. Although shown in FIG. 2 as lining inner walls of the holding frame 8, the thermal paste 16 may be poured into the space and spread out via the insertion of the magnetic piece 7. Thermal paste 16 may also be applied to at least one outer surface of the holding frame 8.

FIGS. 3 to 6 show modifications to magnetic pieces 7 of the gap distribution device 6 of the magnetic component 1 according to the first embodiment shown in FIGS. 1 and 2. FIGS. 3 to 6 especially show a plane-perpendicular cross-sectional surface area of the magnetic pieces 7, wherein the cross-section is plane-perpendicular to the gap extension direction 5.

As can be taken therefrom, the cross-sectional shape of the magnetic pieces 7 in a plane perpendicular to the gap extension direction 5 may be substantially rectangular or circular. Further, the cross-sectional shape of the magnetic pieces 7 may be substantially oval and/or elliptical and/or triangular. Further, the magnetic pieces 7 may comprise a combination of the aforementioned cross-sectional shapes. For instance, one magnetic piece 7 may be substantially rectangular, whereas another magnetic piece 7 is substantially elliptical, etc.

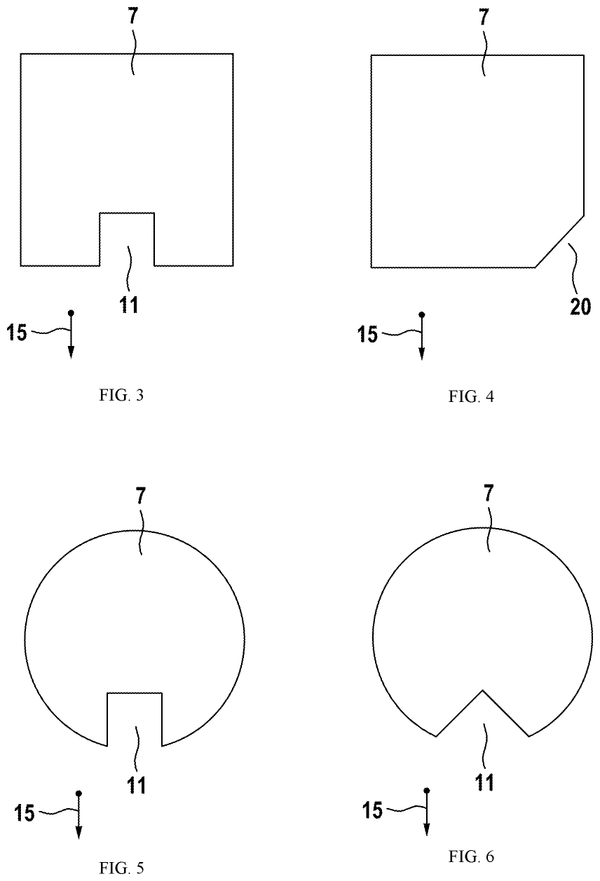

Furthermore, as shown in FIGS. 3, 5 and 6, each of the magnetic pieces 7 comprises a notch 11. As shown in FIG. 4, the magnetic piece(s) may additionally or alternatively comprise a cutout 20.

Therein, the holding frame 8 of the gap distribution device 6 comprises a projection (not shown) which is configured to be insertable into the notch 11 or configured to abut against the cutout 20 of the magnetic pieces 7. Thereby, the magnetic pieces 7 cannot only be held more securely within the holding frame 8, but also a non-linear inductance may be provided by the one or more magnetic pieces 7. In other words, due to the cross-sectional shape of the magnetic pieces 7 not being uniform, i.e. comprising for instance a notch 11, the inductance provided thereby may be made non-linear, thereby providing higher power density and beneficial magnetic characteristics of the magnetic component 1.

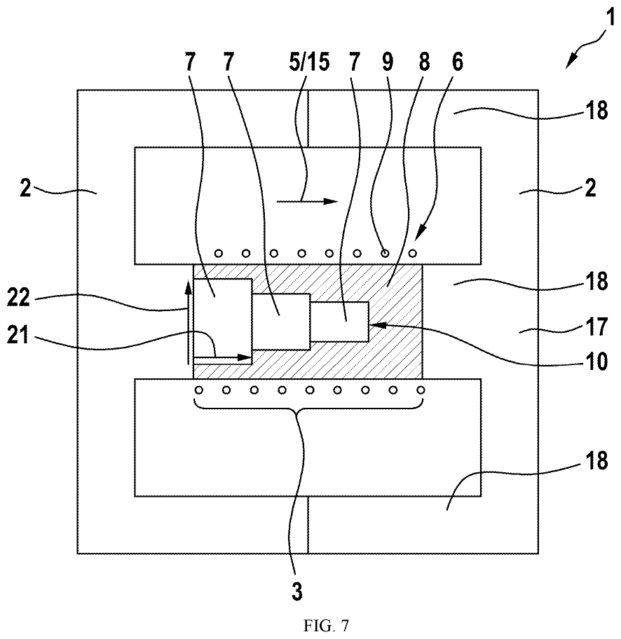

FIG. 7 shows a schematic cross section of a magnetic component 1 according to a second embodiment.

As a comparison of FIG. 7 with FIG. 1 shows, the holding frame 8 of the present embodiment encompasses the magnetic pieces 7 on three sides thereof.

Furthermore, a cross-sectional surface area plane-parallel to the gap extension direction 5 of the magnetic pieces 7 decreases along the gap extension direction 5. In other words, along the gap extension direction 5 from left to right in FIG. 7, a cross-sectional surface area plane-parallel to the gap extension direction 5 (and plane-parallel to the insertion direction 15) of the magnetic pieces 7 continuously decreases. In yet other words, the cross-sectional surface area of the leftmost magnetic piece 7 is greater than that of the middle magnetic piece 7 and greater than that of the rightmost or third magnetic piece 7. Therein, a height 22 and a thickness 21 of each of the magnetic pieces 7 defines the cross-sectional surface area plane-parallel to the gap extension direction 5. Therein, a height 22 continuously decreases between the magnetic pieces 7 along the gap extension direction 5.

Furthermore, as can be taken from FIG. 7, the thickness 21 parallel to the gap extension direction 5 of the magnetic pieces 7 increases continuously along the gap extension direction 5. In other words, the first magnetic piece 7 on the left side is thinner than the middle magnetic piece 7 and also thinner than the third magnetic piece 7 on the right side, which is also thicker than the middle magnetic piece 7.

In addition or alternatively to the cross-sectional surface area plane-parallel to the gap extension direction 5 of the magnetic pieces 7 decreasing, their cross-sectional surface area plane-perpendicular (shown in FIGS. 3 to 6) to the gap extension direction 5 may also decrease. On the other hand, both dimensions defining a cross-sectional surface area (for instance height 22 and depth for plane-perpendicular) may be suitably adapted such that the cross-sectional surface area is changed only for one out of plane-parallel and plane-perpendicular. For instance, if the height 22 is changed so as to change the plane-parallel surface area (for instance, by not changing the thickness 21, or changing the thickness 21 in a manner independent of the change in height 22), then the depth may be changed correspondingly, so as to result in a change in plane-parallel surface area, but not a change in plane-perpendicular surface area (change in depth=change in height for rectangular magnetic pieces 7). In the case of circular magnetic pieces 7, these examples correspond to changes in thickness 21 versus changes in height 22.

As also demonstrated in FIG. 7, the insertion direction 15 for the magnetic pieces 7 into the holding frame 8 is not necessarily perpendicular to the gap extension direction 5 as shown in FIGS. 1 and 2. Instead, the magnetic pieces 7 may be insertable into the holding frame 8 along an insertion direction 15 parallel to the gap extension direction 5 (compare FIG. 7 with for example FIG. 2).

In an implementation, the magnetic pieces 7 are inserted in the order of smallest height 22 to highest height 22 into the holding frame 8. In other words, in FIG. 7, the rightmost magnetic piece 7 is inserted into the holding frame 8 first, the middle magnetic piece 7 afterwards, and the third, leftmost magnetic piece 7 further afterwards.

Thereby, the gap distribution device 6 provides a distributed gap 3 with a non-linear inductance.

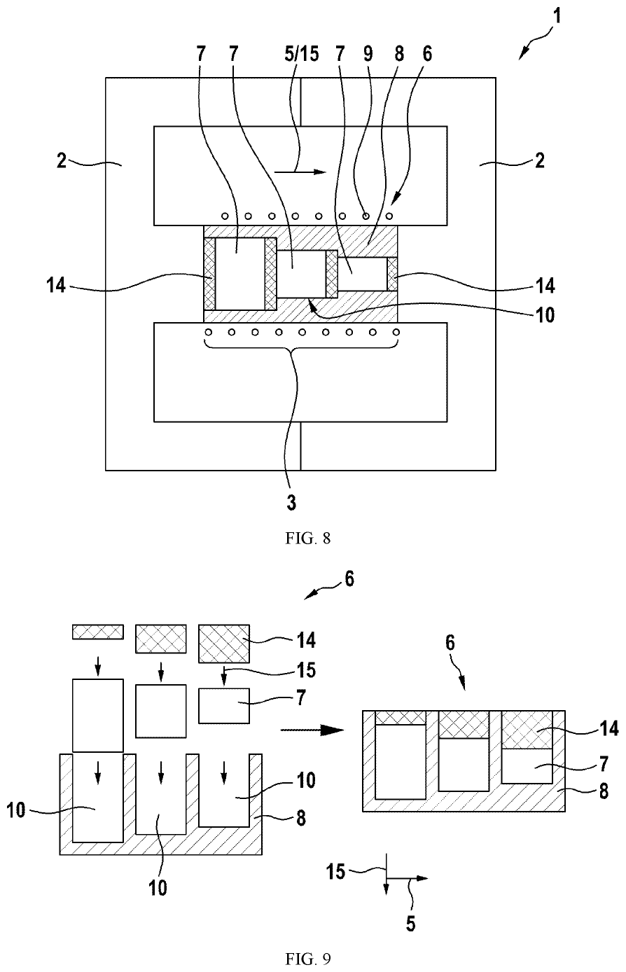

FIG. 8 shows a schematic cross section of a magnetic component 1 according to a third embodiment.

Herein, in comparison to the second embodiment shown in FIG. 7, the spaces 10 of the holding frame 8 extend in gap extension direction 5 throughout the entire holding frame 8. Furthermore, magnetic pieces 7 with continuously decreasing cross-sectional surface areas are inserted into these spaces 10 along the insertion direction 15 parallel to the gap extension direction 5.

Furthermore, the magnetic component 1, in particular the gap distribution device 6, comprises four non-magnetic pieces 14 inserted in the holding frame 8. The non-magnetic pieces 14 comprise a ceramic. In an implementation, the non-magnetic pieces 14 consist of a ceramic.

The non-magnetic pieces 14 are inserted into the holding frame 8 along the insertion direction 15 parallel to the gap extension direction 5. Furthermore, in the gap distribution device 6 of the present embodiment, the non-magnetic pieces 14 and the magnetic pieces 7 alternate, such that each magnetic piece 7 is interposed between two non-magnetic pieces 14.

Thereby, an especially non-linear inductance can be achieved via the gap distribution device 6 and the magnetic component 1.

FIGS. 9 to 11 show schematic detailed cross sections of modifications to gap distribution devices 6 of a magnetic component 1 according to the foregoing embodiments shown in FIGS. 1 to 8. Each of FIGS. 9 to 11 particularly show an insertion process of inserting magnetic pieces 7 and/or non-magnetic pieces 14 into the holding frame 8.

In particular, FIG. 9 shows a modification of the gap distribution devices 6 shown in FIGS. 1 and 2. Therein, each of the spaces 10 comprises a cross-sectional shape and/or a cross-sectional surface area different from the cross-sectional shape and/or the cross-sectional surface area of the other spaces 10. In the present embodiment, the cross-sectional surface area of each of the spaces 10 plane-perpendicular to the gap extension direction 5 and plane-parallel to the insertion direction 15 continuously decreases along the gap extension direction 5. Furthermore, along with a continuously decreasing cross-sectional surface area of the magnetic pieces 7 herein, cross-sectional surface areas of the non-magnetic pieces 14 continuously increase along the gap extension direction 5.

In a modification (not shown), the continuous change of cross-sectional surface area of the non-magnetic pieces 14 along the gap extension direction 5 is configured so as to inversely correspond to the continuous decrease of cross-sectional surface areas of the magnetic pieces 7, such that the cross-sectional surface areas of the spaces 10 may be formed so as to be equal to one another. In other words, the continuously changed cross-sectional surface areas of the magnetic pieces 7 and the non-magnetic pieces 14 may be suitably adapted so as to correspondingly fit into the equal spaces 10 of the holding frame 8 shown in FIG. 2.

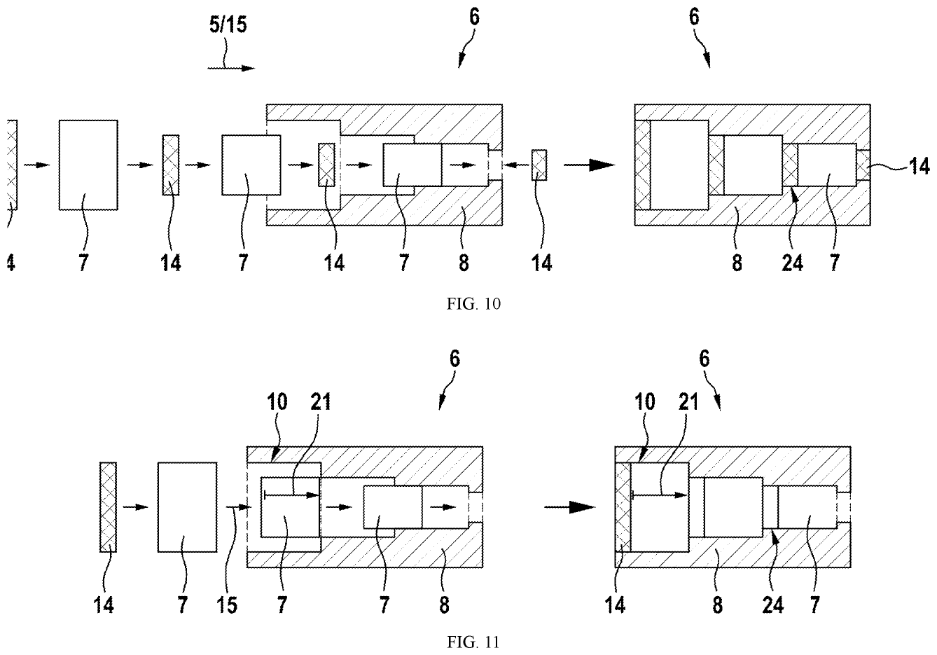

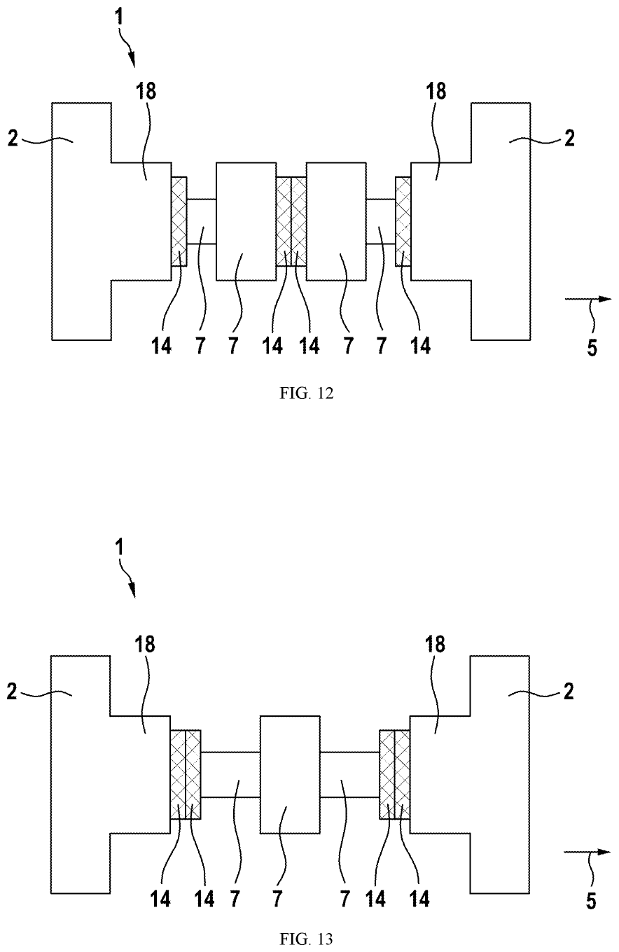

FIGS. 10 and 11 particularly show modifications to the gap distribution device 6 shown in FIGS. 7 and 8.

As shown in FIG. 10, magnetic pieces 7 and non-magnetic pieces 14 are inserted into the holding frame 8 along an insertion direction 15 parallel to the gap extension direction 5.

As a comparison of FIG. 10 with FIG. 11 shows, spaces 24 formed by thickness 21 differences of the spaces 10 and of the magnetic pieces 7 may be filled with non-magnetic pieces 14 and/or may be left as gaps between the magnetic pieces 7. Furthermore, the spaces 24 may be filled with thermal paste 16 or with a magnetic powder.

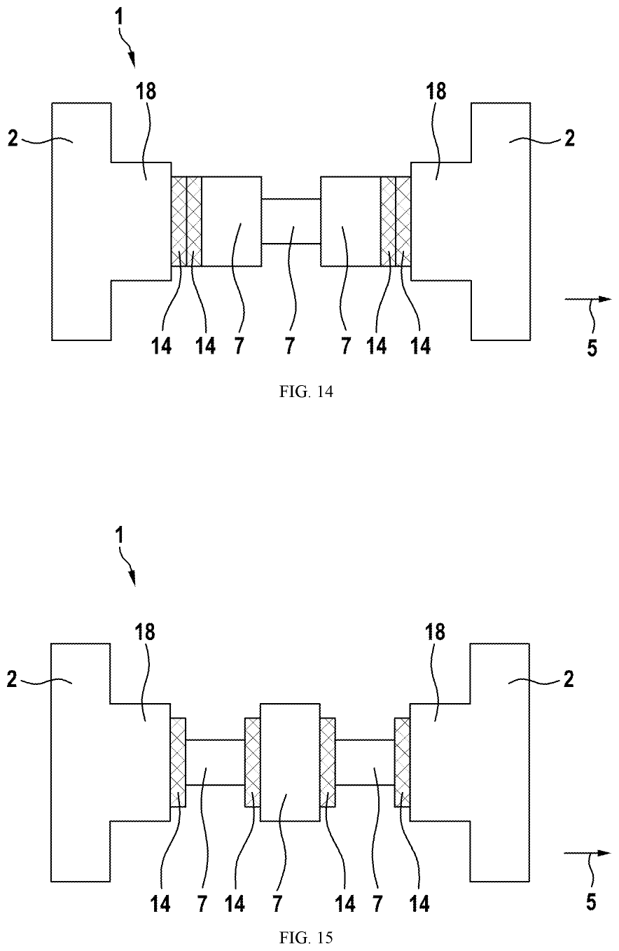

FIGS. 12 to 23 show schematic cross sections of modifications to magnetic components 1 according to the foregoing embodiments.

In particular, for ease of understanding, the holding frame 8 has been omitted therefrom, but is to be understood as being included therein.

In particular, FIGS. 12 to 17 show modifications of the gap distribution device 6 with different configurations of magnetic pieces 7 and non-magnetic pieces 14.

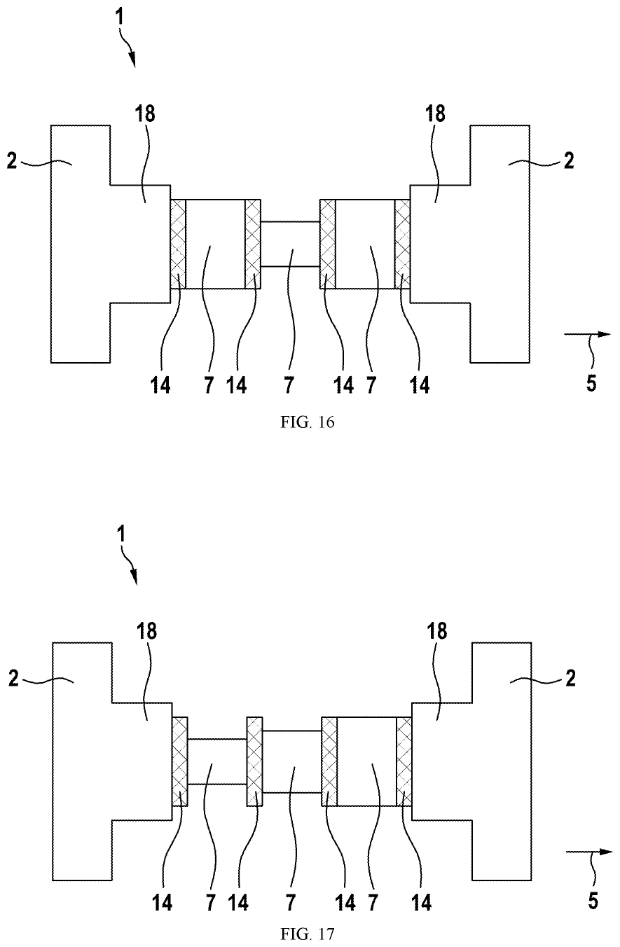

Therein, FIGS. 12, 13, 15 show cross-sectional surface areas of the plurality of magnetic pieces 7 alternating so as to define an inverted H-shape. Furthermore, FIGS. 14 and 16 particularly disclose an H-shape configuration of alternating cross-sectional surface areas of the plurality of magnetic pieces 7.

As a further comparison of FIGS. 12 to 17 shows, the number of non-magnetic pieces 14 and magnetic pieces 7 may be suitably varied in accordance with power density and inductance requirements to the magnetic component 1.

Furthermore, as a comparison of FIG. 17 with FIGS. 12 to 16 shows, as also shown in FIGS. 7 to 11, the cross-sectional surface areas of the magnetic pieces 7 and/or non-magnetic pieces 14 may change so as to define an asymmetrical shape. Therein, these configurations are not symmetrical, i.e. not mirrored, with respect to a center of the gap 3 along the gap extension direction 5.

In contrast thereto, the configurations shown in FIGS. 1, and 12 to 16 are defined as symmetrical.

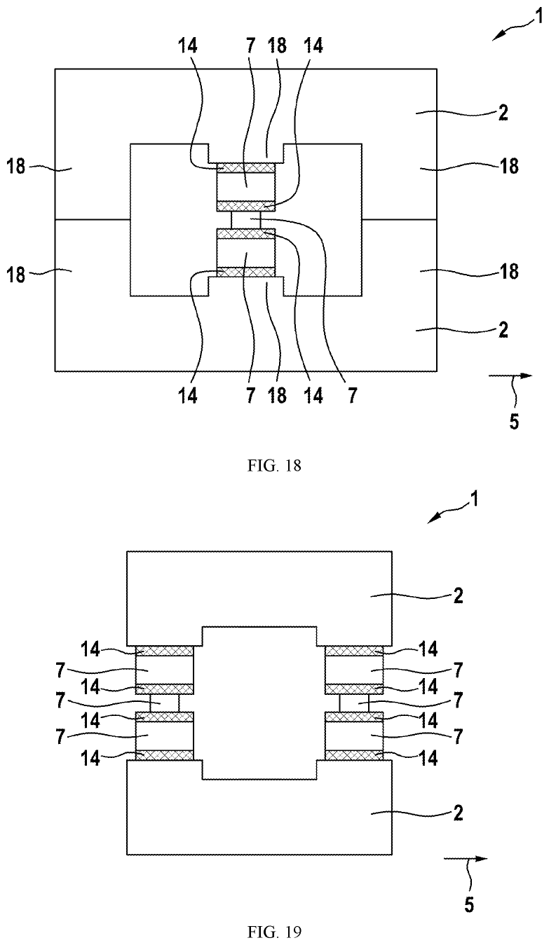

FIGS. 18 to 22 particularly show modifications to the magnetic component 1 with the exemplary configuration of magnetic pieces 7 and non-magnetic pieces 14 shown in FIG. 16.

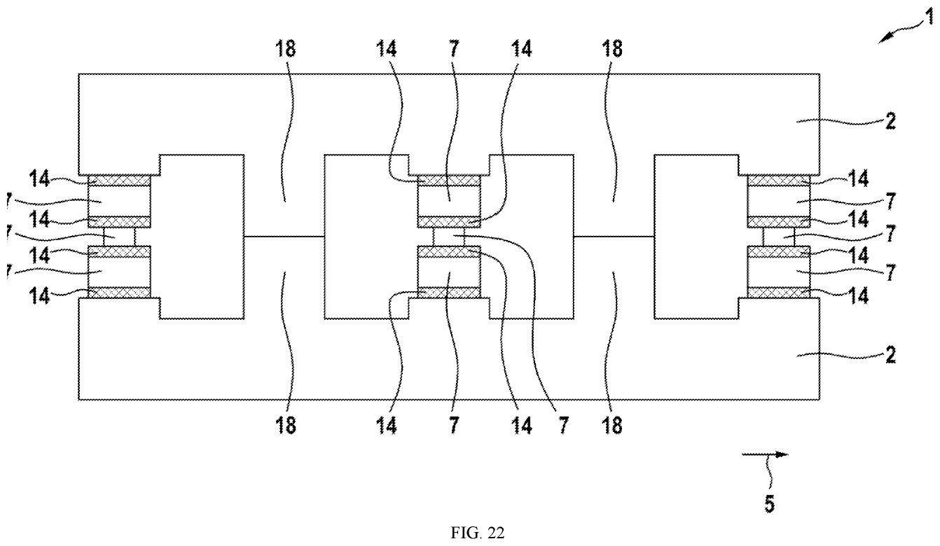

As can be taken from the comparison of FIGS. 18 to 22, the magnetic component 1 may comprise magnetic cores 2 with any number of legs 18. In particular, FIGS. 18, 20, 21 show magnetic cores 2 each with three legs 18. FIG. 19 shows a configuration of magnetic cores 2 each having two legs 18. FIG. 22 shows a configuration of magnetic cores 2 each having five legs 18.

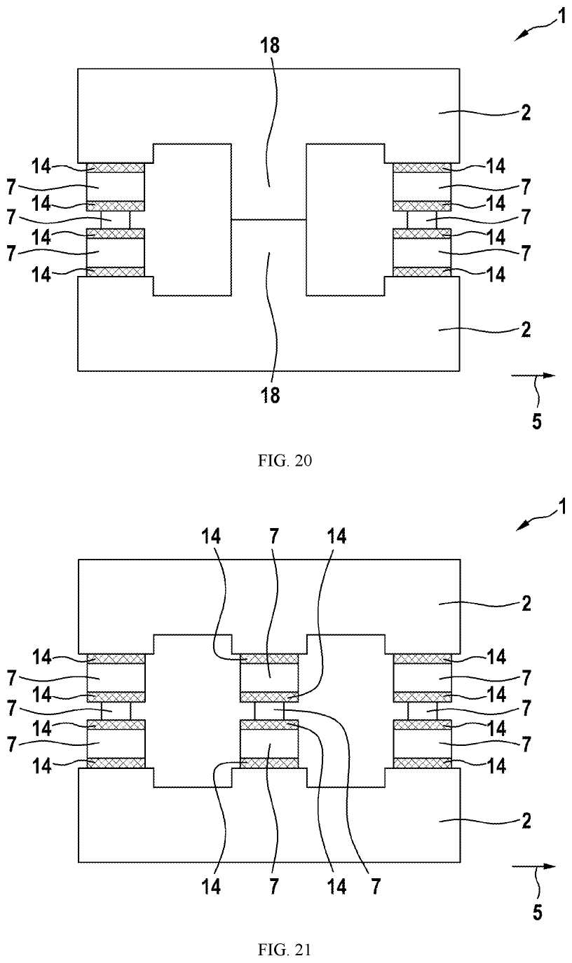

In FIG. 18, the middle leg 18 is a winding leg, and the outer two legs 18 are return legs. In FIG. 19, both legs 18 are winding legs. In FIG. 20, the outer legs 18 are winding legs, and the middle leg 18 is a return leg. In FIG. 21, all three legs are winding legs.

In FIG. 22, the outer legs 18 and the middle leg 18 are winding legs, whereas the interposed second and fourth legs 18 (from left to right) are return legs.

It should, however, be noted that not only winding legs may comprise the gap distribution device 6. For instance, as shown in FIG. 19, both legs 18 may comprise the gap distribution device 6. However, it is that only one of the two legs 18 also comprises an electrical winding. In other words, one of the gap distribution devices 6 shown in FIG. 19 is not surrounded by an electrical winding 9 (compare FIGS. 1 and 7 for example). Thereby, it is also possible to tune an inductance of return legs of the magnetic component 1. On the other hand, it should be noted that both legs 18 shown in FIG. 19 may comprise an electrical winding.

In an implementation, electrical windings 9 (compare FIGS. 1 and 7) may be provided around any one of the winding legs 18, i.e. winding leg pairs, shown in FIGS. 19 to 22.

Furthermore, in general, one or more gap distribution devices 6 may be disposed in any one, multiple, or all winding legs and/or return legs. For instance, the gap distribution device 6 is (additionally or alternatively) used to tune an inductance of return legs.

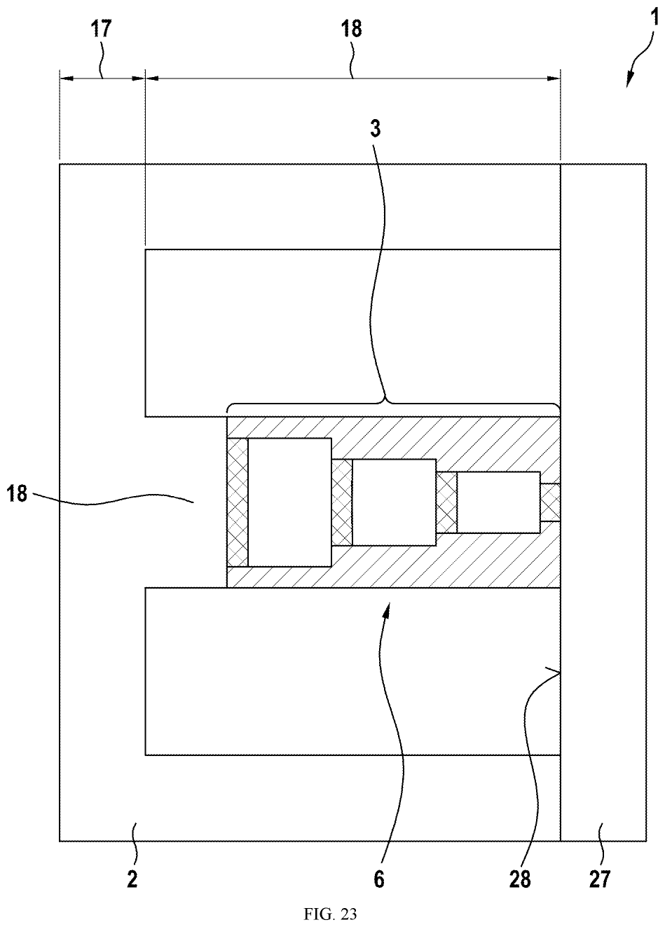

FIG. 23 shows a schematic cross section of a modification of the magnetic component 1 according to the foregoing embodiments.

In the foregoing embodiments, exemplary cases were discussed in which the magnetic component comprises two opposing magnetic cores 2 each comprising a body portion 17 and legs 18. However, in general, as can be taken from FIG. 23, the magnetic component 1 of the embodiments may comprise one magnetic core 2 comprising a body portion 17 and legs 18 as well as an I-shaped magnetic core 27.

Herein, the gap 3 is provided between an end surface of a leg 18 and a side surface 28 of the I-shaped magnetic core 27.

In an implementation, the gap distribution device 6 is provided between a shorter leg (middle leg of FIG. 23) and the I-shaped magnetic core 27, with the longer legs (outer legs) 18 of the magnetic core 2 extending to the I-shaped magnetic core 27.

In general, in addition or alternatively thereto, the gap distribution device 6 may replace any one, multiple, or all legs 18 of at least one magnetic core 2. For instance, in view of FIG. 1, any one or multiple or all legs 18 of the magnetic cores 2 may respectively or pair-wise be replaced by at least one gap distribution device 6. Thereby, for instance in case all legs 18 of both magnetic cores 2 shown in FIG. 1 are replaced respectively by at least one gap distribution device 6, the magnetic component 1 comprises two I-shaped magnetic cores 27 (shown in FIG. 23) as well as the gap distribution devices 6 therebetween. In such an exemplary case, the gap 3 is defined as being located between two opposing side surfaces 28, each being a side surface 28 of one of the two I-shaped magnetic cores 27.

In other words, any one of the foregoing described magnetic cores 2 may be replaced by an arrangement of I-shaped magnetic core(s) 27 with one or more gap distribution devices 6.

Such configurations are for example referred to as “UI”, “WI”, “EI” arrangements. Furthermore, an “II” arrangement is also possible, with gap distribution device(s) 6 arranged between the I-shaped magnetic cores 27 thereof (between the side surfaces of the “I's” in “II” for example).

The I-shaped magnetic core 27 shown as having an I-shape in cross-section is plate-shaped.

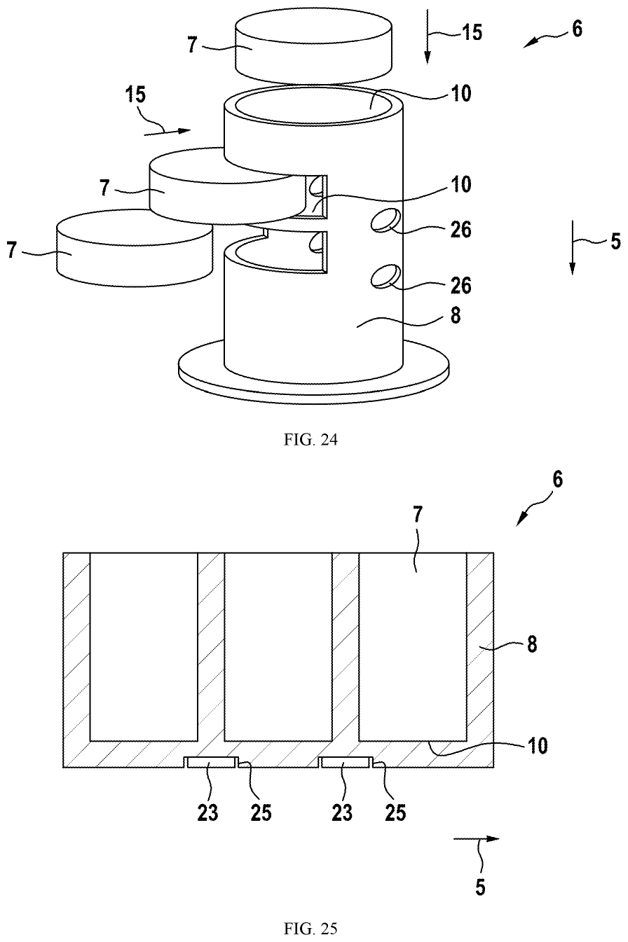

FIG. 24 shows a perspective view of a gap distribution device 6 of the magnetic component 1 according to the foregoing embodiments.

As can be taken therefrom, a cross-sectional shape of the holding frame 8 is substantially cylindrical. Furthermore, as a comparison of FIG. 24 with FIG. 2 and with FIGS. 10 and 11 shows, the holding frame 8 of FIG. 24 combines two spaces 10 shown in FIG. 2 with at least one space 10 shown in FIGS. 10 and 11. In other words, the magnetic pieces 7, i.e. the ferrite plates 7, may be inserted along an insertion direction 15 which is perpendicular to the gap extension direction 5 (for the two bottom spaces 10) as well as inserted along the insertion direction 15 parallel to the gap extension direction 5 (for the top space 10 of the holding frame 8).

As can be taken from FIG. 24, the holding frame 8 may additionally comprise through holes 26 for injecting thermal paste and/or thermal glue, especially for fixing the magnetic pieces 7 in place after insertion thereof. In particular, the through holes 26 (via the thermal paste and/or thermal glue) allow for thermal contact to the magnetic pieces 7 from the outside, for instance for a heat sink.

Further, as shown in FIG. 24, the magnetic pieces 7 may be ferrite pills. In addition or alternatively thereto, the non-magnetic pieces 14 (not shown in FIG. 24) may be ceramic pills.

FIG. 25 shows a schematic cross-section of a gap distribution device 6 of a magnetic component 1 according to a fourth embodiment.

In particular, as can be taken from FIG. 25, the holding frame 8 of the gap distribution device 6 of the present embodiment further comprises at least one, in this embodiment two, recesses 25. Therein, in each recess 25, a fringing field shield plate 23 is disposed. The fringing field shield plates 23 shield fringing fields generated between the magnetic pieces 7 within the gap 3. In an implementation, the fringing field shield plates 23 are also formed of a magnetic material. In an implementation, the fringing field shield plates 23 are formed of the same material as the magnetic pieces 7, ferrite.

In an implementation, one fringing field shield plate 23 is disposed adjacent to a gap formed between two magnetic pieces 7. In an implementation, although FIG. 25 shows fringing field shield plates 23 only on one side (i.e. bottom side) of the holding frame 8, fringing field shield plates 23 and recesses 25 may also be disposed on the other side of the holding frame 8 (i.e. top side).

Further, the recesses 25 are not (only) necessarily disposed or formed on outer surfaces of the holding frame 8. In addition or alternatively thereto, the recesses 25 are formed within the holding frame 8. For instance, the fringing field shield plates 23 are formed integrally with the holding frame 8, for example via injection molding.

In addition to the foregoing written explanations, it is explicitly referred to FIGS. 1 to 25, wherein the figures in detail show configuration examples of the disclosure.

What is claimed is:

1. A magnetic component, comprising:
at least one magnetic core, wherein at least one gap is formed between surfaces of the at least one magnetic core, wherein a direction extending between said surfaces is defined as a gap extension direction;
a gap distribution device comprising at least one magnetic piece and at least one holding frame configured to hold the at least one magnetic piece, wherein the gap distribution device is arranged within said at least one gap of the at least one magnetic core such that the at least one magnetic piece is arranged within said gap; and
at least one electrical winding wound around the at least one magnetic core and/or the at least one holding frame of the gap distribution device.

2. The magnetic component according to claim 1, wherein at least one gap is formed between opposing end surfaces of magnetic cores, or
at least one gap is formed between opposing side surfaces of magnetic cores, or
at least one gap is formed between an end surface of a first magnetic core and a side surface of a second magnetic core, wherein the end surface and the side surface are opposing.

3. The magnetic component according to claim 1, wherein the holding frame comprises a plurality of spaces, each configured to accommodate at least one magnetic piece.

4. The magnetic component according to claim 3, wherein at least two of the spaces of the holding frame comprises different cross-sectional shapes and/or cross-sectional surface areas.

5. The magnetic component according to claim 3, wherein the at least one magnetic piece is insertable into the holding frame along an insertion direction parallel to the gap extension direction.

6. The magnetic component according to claim 1, further comprising a plurality of magnetic pieces, wherein at least two of the magnetic pieces comprise different cross-sectional shapes and/or cross-sectional surface areas.

7. The magnetic component according to claim 6, wherein the cross-sectional shapes of the plurality of magnetic pieces change and/or the cross-sectional surface areas of the plurality of magnetic pieces decrease along the gap extension direction.

8. The magnetic component according to claim 7, wherein the cross-sectional shapes of the plurality of magnetic pieces continuously change and/or the cross-sectional surface areas of the plurality of magnetic pieces continuously decrease along the gap extension direction.

9. The magnetic component according to claim 6, wherein the cross-sectional shapes and/or the cross-sectional surface areas of the plurality of magnetic pieces alternate.

10. The magnetic component according to claim 9, wherein the cross-sectional shapes and/or the cross-sectional surface areas of the plurality of magnetic pieces alternate so as to define, from a side-view perpendicular to the gap extension direction, an H-shape or an inverted H-shape.

11. The magnetic component according to claim 1, wherein at least one of the magnetic pieces comprises at least one notch and/or at least one groove, and wherein the at least one holding frame respectively comprises a projection configured to be insertable into the at least one notch and/or at least one groove.

12. The magnetic component according to claim 11, wherein the projection is rib-shaped and extends along the gap extension direction so as to be insertable into the at least one notch and/or the at least one groove of a plurality of magnetic pieces.

13. The magnetic component according to claim 1, wherein a cross-sectional shape of the at least one holding frame is circular and/or rectangular.

14. The magnetic component according to claim 1, further comprising at least one non-magnetic piece arranged within the at least one gap.

15. The magnetic component according to claim 14, wherein the non-magnetic piece comprises a ceramic piece.

16. The magnetic component according to claim 14, wherein the at least one non-magnetic piece is configured to be housed within the holding frame.

17. The magnetic component according to claim 14, wherein at least one space of the holding frame is configured to respectively accommodate at least one magnetic piece and at least one non-magnetic piece.

18. The magnetic component according to claim 14, wherein the at least one non-magnetic piece and the at least one magnetic piece are stacked along the gap extension direction and/or stacked in a direction perpendicular to the gap extension direction.

19. The magnetic component according to claim 1, further comprising thermal paste disposed in the at least one holding frame and/or disposed between the at least one holding frame and at least one of the surfaces of the at least one magnetic core.

20. The magnetic component according to claim 1, comprising multiple magnetic cores, wherein at least one of the magnetic cores comprises a body portion and at least one leg, the at least one leg extending along the gap extension direction, wherein the at least one gap is formed between a respective end surface of the at least one leg and a surface of another magnetic core.
